(19) United States
(12) Patent Application Publication
(10) Pub. No.: US 2010/0096162 A1
(43) Pub. Date: Apr. 22, 2010

(54) Lightweight copper/aluminum composite conductors

(76) Inventor: Emilio Cerra, Spartanburg, NC (US)

Correspondence Address: Daniel H. Steidl;KILGANNON & STEIDL, 85 Pondfield Road, Bronxville, NY, 10708, US

(21) Appl. No.: 12/288,688

(22) Filed: Oct. 22, 2008

(51) Int. Cl. H01B 5/08

(52) U.S. Cl. 174/126.2

(57) ABSTRACT

A lightweight composite electrical conductor for aerospace applications, having a core of a plurality of aluminum strands surrounded by an outer layer of a plurality of copper strands. The conductor may be a wire rope having a core of a plurality of aluminum members each having a plurality of aluminum strands, the core of aluminum members being surrounded by an outer layer of a plurality of copper members each having a plurality of copper strands.

### FIELD OF THE INVENTION

This invention relates to electrical conductors, and more particularly lightweight conductors for the aerospace industry.

### BACKGROUND OF THE INVENTION

Weight reduction is a relentless, never ending task for aircraft manufacturers. In the realm of aerospace cables, however, there has been little reduction in weight over the past decade, and what has occurred has been primarily due to insulation system improvements.

Copper alloys have been used in aerospace cables for many years. In more recent years, EC aluminum and copper clad aluminum ropes have been used in power feeder applications by certain aerospace companies; these conductors, however, require special care during manufacture and termination in order to avoid potential electrical failures.

The introduction of popular new airplanes such as the Boeing 787 Dreamliner and Airbus A380 that promise significantly lower fuel consumption and operating costs have placed enormous pressure on aerospace engineers to reduce weight in all areas of the aircraft. One proposed conductor solution, nickel plated aluminum and/or nickel plated copper clad aluminum, has the unfortunate tendency to form cracks in the nickel coating. To date these voids have been managed via careful control of the manufacturing and assembly processes; nevertheless, the potential for adverse situations exists.

There is thus a need for new aerospace conductors with significantly lower weight relative to equivalent copper conductors, that are an economical alternative to existing conductors, that are easy to install and capable of utilizing existing connector/crimp technologies, and that are designed for manufacturability.

### SUMMARY OF THE INVENTION

The present invention comprises a composite configuration of conductor that utilizes both copper and aluminum strands. The composite conductor reduces conductor weight relative to an equivalent copper conductor, does not significantly impact conductor resistance, and does not change the methods with which aerospace conductors are terminated.

More particularly, the composite conductors utilize a core made of twisted aluminum strands surrounded by an outer layer of twisted copper wires. The aluminum strands are limited exclusively to the core layers inward of the outer copper layer, to avoid the need for special connectors. There is no barrier between the aluminum and copper strands, and insulation surrounds the outer layer of copper wires. Constructions typically may contain 19 or 37 wires, or 19 or 37 members in the case of a rope. In the case of a rope, for example, a 1/o gauge rope could contain 37 members with 19 members in the aluminum core and 18 members in the copper outer layer. Each of the thirty-seven members could contain 7 wire strands of 24 gauge, identified in shorthand nomenclature as 37×7/24. Aluminum and copper are not mixed in the individual members nor in the layers. The 19 member core can be made of 1350 EC aluminum strands and the 18 member outer layer can be made of ETP copper strands (which can be coated to inhibit any incipient corrosion).

Correspondingly, in the case of a 19 wire or member conductor, there could be 7 wire strands or members of aluminum in the inner core and 12 wire strands or members of copper in the outer layer. These geometric constraints drive the physical characteristics of the cables; therefore a 37 wire cable will contain more aluminum as a percentage of the total conductor (51.4%) than 19 wire cable (36.8%). Accordingly, the 37 wire conductor will weigh less and be lower in conductivity than a similar sized conductor using 19 wires.

Other features and advantages of the present invention will be apparent from the following description, drawings and claims.

### BRIEF DESCRIPTION OF THE DRAWINGS

FIG. 1 is a cross-sectional view of a copper/aluminum composite conductor of the present invention, being a 37 member composite rope having a 19 member core of aluminum and an 18 member outer layer of copper;

FIG. 2 is a cross-sectional view of a copper/aluminum composite conductor of the present invention, being a 19 member composite rope having a 7 member core of aluminum and a 12 member outer layer of copper; and

FIG. 3 is a cross-sectional view of a copper/aluminum composite conductor of the present invention, being a 19 strand wire having a 7 strand core of aluminum and a 12 strand outer layer of copper.

### DETAILED DESCRIPTION OF EMBODIMENTS

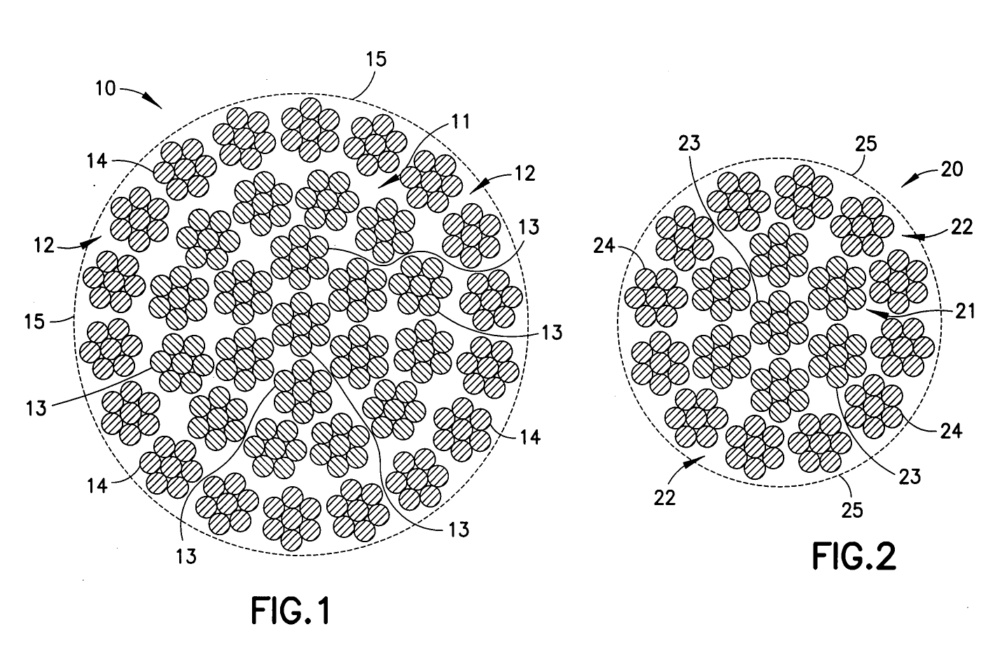

FIG. 1 illustrates the thirty-seven member composite rope 10, having an inner core 11 of nineteen aluminum members and an outer surrounding layer 12 of eighteen copper members. The nineteen aluminum members 13 of the inner core are each comprised of seven twisted aluminum strands. The eighteen copper members 14 of the outer layer 12 surround the inner core 11, and are each comprised of seven twisted copper strands. A layer of insulation is applied over the outer layer 12, and is shown schematically as a circumferential dotted line 15.

FIG. 2 illustrates the nineteen member composite rope 20, having inner core 21 of seven aluminum members and surrounding outer layer 22 of twelve copper members. The seven aluminum members 23 of the inner core again are each comprised of seven twisted aluminum strands. The twelve copper members 24 of outer layer 22 surround the inner core 21, and are again each comprised of seven twisted copper strands. A layer of insulation 25, shown schematically as circumferential line 25, is applied over the outer layer 22.

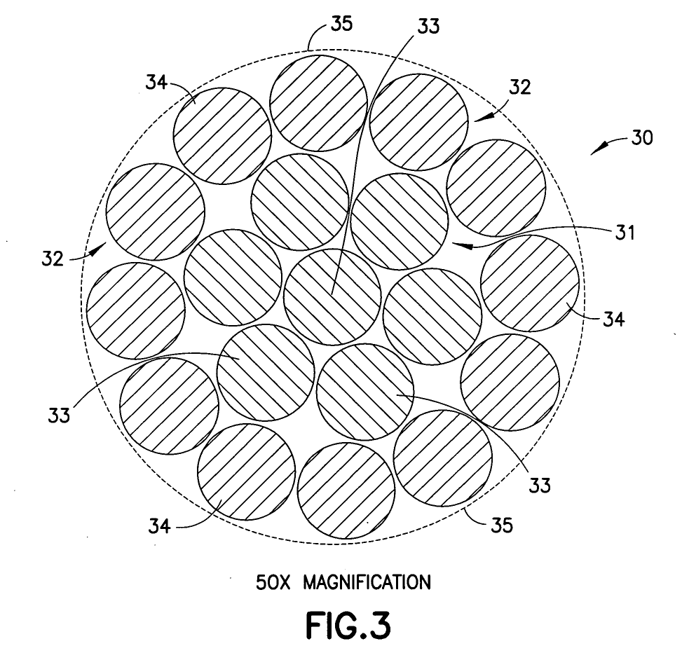

FIG. 3 illustrates a greatly enlarged copper/aluminum composite conductor that is not a rope with members, but rather a nineteen strand wire 30 having an inner core 31 of seven aluminum strands 33, and a surrounding outer layer 32 of twelve copper strands 34. A layer of insulation, shown schematically as circumferential dotted line 35, is applied over the outer layer 32. Wire 30 may be, for example, a 22 AWG (19×34) unilay, the unilay having all nineteen strands of 34 gauge each twisted in the same direction. The seven aluminum strands may be of aluminum alloy 5254, for example, for a potentially higher flex life or tensile strength.

The primary purpose of these aerospace copper/aluminum composite conductors is weight reduction, as previously discussed above. Tables 1 and 2 below show expected weight and direct current resistance (DCR) values for a representative sample of wires and ropes in both composite copper/aluminum (Table 1) and conventional copper (Table 2) constructions. The copper strands are nickel plated.

TABLE 1
Composite Copper/Aluminum Conductor Properties

| | | Weight | DCR |
|---|---|---|---|
| Size | Construction | (lbs/kft) | (Ω/kft) |
| 22 | 19 × 34 | 1.61 | 18.480 |
| 20 | 19 × 32 | 2.60 | 11.250 |
| 18 | 19 × 30 | 4.13 | 7.060 |
| 16 | 19 × 29 | 5.25 | 5.520 |
| 14 | 19 × 27 | 8.25 | 3.470 |
| 12 | 37 × 28 | 11.06 | 2.440 |
| 10 | 37 × 26 | 17.92 | 1.530 |
| 8 | 19 × 7/29 | 37.10 | 0.803 |
| 6 | 19 × 7/27 | 58.70 | 0.504 |
| 4 | 19 × 7/25 | 95.40 | 0.318 |
| 2 | 19 × 35/30 | 146.00 | 0.205 |
| 1 | 19 × 43/30 | 173.00 | 0.167 |
| 1/0 | 19 × 55/30 | 228.00 | 0.131 |
| 2/0 | 19 × 70/30 | 292.00 | 0.103 |
| 3/0 | 37 × 45/30 | 316.00 | 0.088 |
| 4/0 | 37 × 57/30 | 397.00 | 0.069 |

TABLE 2
Conventional Copper Conductor Properties

| | | Weight | DCR |
|---|---|---|---|
| Size | Construction | (lbs/kft) | (Ω/kft) |
| 22 | 19 × 34 | 2.17 | 16.000 |
| 20 | 19 × 32 | 3.50 | 9.770 |
| 18 | 19 × 30 | 5.56 | 6.100 |
| 16 | 19 × 29 | 7.06 | 4.770 |
| 14 | 19 × 27 | 11.10 | 3.000 |
| 12 | 37 × 28 | 17.22 | 1.980 |
| 10 | 37 × 26 | 27.90 | 1.240 |
| 8 | 19 × 7/29 | 49.90 | 0.694 |
| 6 | 19 × 7/27 | 79.00 | 0.436 |
| 4 | 19 × 7/25 | 128.30 | 0.275 |
| 2 | 19 × 35/30 | 196.00 | 0.177 |
| 1 | 19 × 43/30 | 233.00 | 0.144 |
| 1/0 | 19 × 55/30 | 307.00 | 0.113 |
| 2/0 | 19 × 70/30 | 393.00 | 0.089 |
| 3/0 | 37 × 45/30 | 492.00 | 0.071 |
| 4/0 | 37 × 57/30 | 618.00 | 0.056 |

Generally speaking, a nineteen wire composite construction will be 26% lighter than an equivalent copper conductor, with direct current resistance (DCR) 16% higher than the same. A thirty-seven wire composite construction will be 36% lighter but 24% higher in resistance than an equivalent copper conductor. In applications where resistance is of primary importance and DCR values must be maintained, increasing overall conductor size by approximately 6% in the nineteen wire, and 9% in the thirty-seven wire, composite constructions will ensure that resistance will be unchanged. These cables will still be 14% and 21% lighter than their nineteen and thirty-seven wire counterparts.

An insulated composite 1/o gauge rope (37×7/24) evaluation sample has been tested and passed certain conductor related tests of bend radius, stiffness, tensile and elongation. Flexure endurance tests (which have no industry standard), corrosion tests, crimpability tests including lug pull tests, thermal shock tests, vibration analysis, etc. require further attention. Other aluminum alloys for the aluminum core, including alloy 5254, will be tested to obtain higher flex life or tensile strength if required.

It will be appreciated by persons skilled in the art that variations and/or modifications may be made to the present invention without departing from the spirit and scope of the invention. The present embodiments are, therefore, to be considered as illustrative and not restrictive.

What is claimed is:

1. A lightweight composite electrical conductor, comprising in combination a core of a plurality of aluminum strands surrounded by an outer layer of a plurality of copper strands.

2. The conductor of claim 1, wherein said conductor is a wire rope having a core of a plurality of aluminum members each having a plurality of aluminum strands, such core of aluminum members being surrounded by an outer layer of a plurality of copper members each having a plurality of copper strands.

3. The conductor of claim 1, comprising 19 wires.

4. The conductor of claim 1, comprising 37 wires.

5. The conductor of claim 2, comprising 19 members.

6. The conductor of claim 2, comprising 37 members.

7. The conductor of claim 3, comprising 7 aluminum wires and 12 copper wires.

8. The conductor of claim 4, comprising 19 aluminum wires and 18 copper wires.

9. The conductor of claim 5, comprising 7 aluminum members and 12 copper members.

10. The conductor of claim 6, comprising 19 aluminum members and 18 copper members.

11. The conductor of claim 1, the aluminum strands being comprised of 1350 EC aluminum and the copper strands being comprised of nickel plated ETP copper.

12. The conductor of claim 1 or claim 2, wherein the aluminum strands are confined exclusively to the core.

13. The conductor of claim 1 or claim 2, wherein the aluminum strands are comprised of aluminum alloy 1350.

14. The conductor of claim 1 or claim 2, wherein the aluminum strands are comprised of aluminum alloy 5254.

15. The conductor of claim 1 or claim 2, having an insulation layer over the outer layer.

16. The conductor of claim 1 or claim 2, wherein the aluminum strands are twisted.
